(19) United States
(12) Patent Application Publication
(10) Pub. No.: US 2024/0182713 A1
(43) Pub. Date: Jun. 6, 2024

(54) COMPOSITE COMPOSITION COMPRISING ARAMID COPOLYMER PARTICLES AND A THERMOPLASTIC ENGINEERING POLYMER AND ARTICLES COMPRISING SAME

(71) Applicant: DUPONT SAFETY & CONSTRUCTION, INC, Wilmington, DE (US)

(72) Inventors: Kathleen Opper, Greenville, DE (US); Kevin Kaurich, Richmond, VA (US); Teresa Madeleine, Wilmington, DE (US); Jacob Pretko, Richmond, VA (US)

(21) Appl. No.: 18/497,222

(22) Filed: Oct. 30, 2023

Related U.S. Application Data
(60) Provisional application No. 63/384,292, filed on Nov. 18, 2022.

(51) Int. Cl. C08L 77/10; B29C 48/00; B29C 48/40; C08G 65/40; B29K 71/00; B29K 77/00

(52) U.S. Cl. CPC C08L 77/10; B29C 48/022; B29C 48/40; C08G 65/4012; B29K 2071/00; B29K 2077/10; C08G 2650/40; C08L 2205/22

(57) ABSTRACT

A composite composition, and process for making and article comprising same, the composition comprising 3 to 30 parts by weight particles comprising aramid copolymer including an imidazole group, and up to 97 parts by weight of a thermoplastic engineering polymer; wherein said particles are uniformly dispersed in the thermoplastic engineering polymer and reduce the wear rate of the thermoplastic engineering polymer by at least 25 percent.

### BACKGROUND OF THE INVENTION

### Field of the Invention

This invention is a composite composition comprising solid polymeric particles dispersed in an engineering polymer, wherein the combination of the dispersed solid material and the engineering polymer have unexpected mechanical properties. The solid polymeric particles can be such things as polymerized crumb or powder-like particles, or as a floc.

### Description of Related Art

Articles made from engineering polymers in a molten state are highly valued for their ease and flexibility of manufacture. Such articles can be in the form of injection molded parts or parts that have been 3-D printed or additive manufactured, such as by fused deposition modeling (FDM), stereolithography (SLA), or selective laser sintering (SLS). Such parts can be, for example thin-walled parts or industrial large format parts for use in the automotive and/or aerospace industry. Any improvement in compositions containing such engineering polymer that adds additional product features or improved performance is desirable.

### BRIEF SUMMARY OF THE INVENTION

This invention relates to a composite composition, comprising:
a) 3 to 30 parts by weight particles comprising aramid copolymer including an imidazole group, and
b) up to 97 parts by weight of a thermoplastic engineering polymer;
wherein said particles are uniformly dispersed in the thermoplastic engineering polymer and reduce the wear rate of the thermoplastic engineering polymer by at least 25 percent. This invention further relates to an article comprising the said composite composition.

This invention also relates to a process for making a composite composition including the steps of
a) polymerizing monomers to form an aramid copolymer including an imidazole group, the monomers including at least one aromatic diacid and at least one aromatic diamine and one imidazole diamine;
b) comminuting and isolating the aramid copolymer including an imidazole group in the form of a polymer crumb of a desired particle size comprising aramid copolymer including an imidazole group;
c) optionally, further grinding or milling the polymer crumb to form particles comprising aramid copolymer including an imidazole group of a desired particle size; and
d) combining and mixing 3 to 30 parts by weight of said particles with up to 97 parts by weight of a thermoplastic engineering polymer to form the composite composition.

### BRIEF DESCRIPTION OF THE DRAWINGS

FIG. 1 is a photograph at 30× magnification of raw polymer particles having a size generally of 1 mm or greater, and comprising aramid copolymer including an imidazole group, which are dried and rough ground polymer crumb obtained and isolated from the polymerizing step.

FIG. 2 is a photograph at 30× magnification of ground particles having a size generally of less than 1 mm, and comprising aramid copolymer including an imidazole group, which are referred to herein as “dry extruder” particles, which are made from raw polymer particles that are further size-reduced through a twin-screw extruder in a dry state; that is, the particles having less than 10 weight percent moisture.

FIGS. 3 & 4 are photographs at magnification levels of 30× and 100×, respectively, of the same ground particles having a size generally of less than 1 mm, and comprising aramid copolymer including an imidazole group, which are referred to herein as “wet extruder” particles, which are made from water-wet crumb from polymerization that is size-reduced only once in a twin-screw extruder to the desired particle size.

### DETAILED DESCRIPTION OF THE INVENTION

This invention relates to a composite composition and articles made therefrom that contain a blend of thermoplastic engineering polymer and aramid copolymer particles, wherein the aramid copolymer includes an imidazole group in the copolymer chain. Preferably the particles are uniformly dispersed in the thermoplastic engineering polymer. By uniformly dispersed, it is meant the particles are preferably uniformly distributed in the thermoplastic engineering polymer in a random manner that can preferably provide uniform mechanical properties to any article made from the composite composition.

### Composite Composition

Specifically, the composite composition comprises 3 to 30 parts by weight particles comprising aramid copolymer including an imidazole group. These solid materials are uniformly dispersed in up to 97 parts by weight of a thermoplastic engineering polymer in the composition. If only the particles and the thermoplastic engineering polymer are present, then the thermoplastic engineering polymer is used in an amount of 3 to 97 parts by weight in the composition. The resulting composition reduces the wear rate of the thermoplastic engineering polymer by at least 25 percent (when compared to the wear rate of the thermoplastic engineering polymer alone), thereby increasing the wear resistance of the thermoplastic engineering polymer. In some embodiments, the composite composition comprises 5 to 25 parts by weight of the particles comprising aramid copolymer including an imidazole group and 75 to 95 parts by weight of a thermoplastic engineering polymer. In some embodiments, the addition of the particles comprising aramid copolymer including an imidazole group reduces the wear rate of the thermoplastic engineering copolymer by at least 45 percent when compared to the wear rate of the thermoplastic engineering polymer alone. In some embodiments, the addition of the particles comprising aramid copolymer including an imidazole group reduces the wear rate of the thermoplastic engineering copolymer by at least 80 percent when compared to the wear rate of the thermoplastic engineering polymer alone.

It is believed that the wear rate of articles comprising the composite composition are most improved in applications that mimic high pressure-velocity wear, such as shown by the thrust washer (TW) testing shown herein. In those applications, the addition of the particles comprising aramid copolymer including an imidazole group can reduce the wear rate of the thermoplastic engineering copolymer as high as at least 75 percent, preferably at least 80 percent, and most preferably at least 85 percent or greater, when compared to the wear rate of the thermoplastic engineering polymer alone.

The wear rate of articles comprising the composite composition, however, also show improvement in applications that mimic low pressure-velocity wear, such as shown by the three-pad washer (3PW) testing shown herein. In those applications, the addition of the particles comprising aramid copolymer including an imidazole group can reduce the wear rate of the thermoplastic engineering copolymer as high as at least 45 percent, preferably at least 60 percent, even more preferably at least 80 percent or greater, and most preferably at least 85 percent or greater, when compared to the wear rate of thermoplastic engineering polymer alone.

### Adhesion Properties

In addition to improved wear properties, it has been found that the aramid copolymer including an imidazole group has unexpectedly superior adhesion to thermoplastic engineering polymers like PEEK versus para-aramid homopolymers like poly(paraphenylene terephthalamide). It is believed this superior adhesion is in addition to the surprisingly improved wear and other properties the aramid copolymer including an imidazole group can provide to articles.

One method of characterizing improved adhesion properties between materials is found using DIN SPEC 19289:2022-08 “Fibre-reinforced composites—Measurement of Interfacial Shear Strength by means of a Micromechanical Single-Fibre Pull-Out Test”, wherein a fiber of one material is embedded in a matrix of another material, and the forces required to pull this fiber out of the matrix is then measured. (As used herein, the words “fibre”, “fiber”, and “filament” are used interchangeably.) This European Standard defines the “apparent interfacial shear strength” (τₐₚₚ) in MPa as the maximum force normalized to the contact area between the fiber and the solidified matrix, wherein the maximum force is the highest force value appearing just before the complete debonding of the fiber from the matrix during the pullout. Further, the “local interfacial shear strength” (τ_{d}) in MPa is defined as the debonding force related to the contact area of the interface between the fiber and the solidified matrix without the impact of the friction between the fiber and matrix, where the debonding force is the force at which the fiber starts debonding from the solidified matrix. Additionally, the “critical interfacial energy release rate” (G_{ic}) in Joules/square meter is defined as the interfacial toughness, taking the deformation of the fiber and matrix during the pull-out into account. For the purposes of determining adhesion properties herein, the fiber material is the aramid copolymer including an imidazole group and the matrix material is the thermoplastic engineering polymer.

It is believed that in many instances the “local interfacial shear strength” (τ_{d}) can be the best measure of adhesion between the polymer of the fiber material and the polymer of the solidified matrix material because that is the debonding force without the impact of the friction between the fiber and matrix materials; however, all of these designated properties describe the adhesion between the fiber and matrix materials.

The adhesion between fiber material that is the aramid copolymer including an imidazole group and the engineering polymer matrix material using DIN SPEC 19289:2022-08 is directly applicable when the particles of aramid copolymer including an imidazole group are in the form of a floc. Additionally, the particles of aramid copolymer including an imidazole group in the form of a floc may include a surface or spin “finish”. It is well known that such finishes are oils, waxes, or other materials that are used as fiber processing aids to reduce damage to the fiber. It has been found that fiber of the aramid copolymer including an imidazole group that further has a surface finish has an increased “local interfacial shear strength” (τ_{d}) when compared to the τ_{d} of the same fiber material that is finish free; that is, a fiber wherein any surface finish has been removed. It is believed the finish can help the matrix polymer better wet the surface of the fiber for better contact.

Additionally, it is believed the adhesion between a finish-free fiber material, that is the aramid copolymer including an imidazole group, and the engineering polymer matrix material using DIN SPEC 19289:2022-08 is directly applicable when the particles of aramid copolymer including an imidazole group are in the form of raw polymer or ground polymer. It then follows, therefore, that the adhesion properties of polymeric particles to various thermoplastic engineering polymers can be determined, even though the polymeric material might be in various forms, by first making a filament of the polymeric material, ensuring no finish is present, and then embedding the finish-free filament in a matrix of the thermoplastic engineering polymer followed by pulling out the filament, all conducted per the standard DIN SPEC 19289:2022-08.

In some embodiments, the “local interfacial shear strength” (τ_{d}) between the particles of aramid copolymer including an imidazole group and the engineering polymer is greater than the “local interfacial shear strength” (τ_{d}) between the particles of a para-aramid homopolymer such as PPD-T and the same engineering polymer. In some embodiments, the “local interfacial shear strength” (τ_{d}) between the particles of aramid copolymer including an imidazole group and the engineering polymer is at least 9 percent or greater than the “local interfacial shear strength” (τ_{d}) between the particles of a para-aramid homopolymer such as PPD-T and the same engineering polymer. In some preferred embodiments, the “local interfacial shear strength” (τ_{d}) between the particles of aramid copolymer including an imidazole group and the engineering polymer is at least 35 percent or greater than the “local interfacial shear strength” (τ_{d}) between the particles of a para-aramid homopolymer such as PPD-T and the same engineering polymer. In some embodiments, the improvement over PPD-T in local interfacial shear strength using the particles of aramid copolymer including an imidazole group ranges from 25 to 125 percent.

In some embodiments, the local interfacial shear strength (τ_{d}) between the particles of aramid copolymer including an imidazole group and the engineering polymer is 72 MPa or greater and can range as high as 100 MPa or higher.

### Thermoplastic Engineering Polymer

By “thermoplastic engineering polymer” it is meant a polymer that is useful as the sole, primary, or majority polymeric material of construction of a polymeric part or polymeric component of a device. Additionally, as used herein, “thermoplastic” it is meant to have its traditional definition, in that the engineering polymer in solid form can be heated to a liquid state and then cooled back to a solid state, and this cycle can be repeated with little change in the melting point of the copolymer. In many cases, thermoplastic engineering polymers contain aromatic rings as substituents or as part of the polymer backbone, which can be easily substituted or modified to provide additional functionality for specific applications.

Generally, engineering polymers are desirable in articles that may be used at elevated temperatures and one measure is the deflection temperature under load as measured, for example per ASTM D648-07 “Standard Test Method for Deflection Temperature of Plastics Under Flexural Load In the Edgewise Position” (which is equivalent to the ISO 75). This test determines the temperature at which deformation occurs under a specific load, the temperature being known as the heat deflection temperature (HDT). Typically, the HDT can be measured wherein the load value is 1820 kPa, which is commonly referenced as 1.8 MPa (264 psi). In some preferred embodiments the preferred thermoplastic engineering polymer used in the composite composition has an unfilled or “neat” HDT of 100 C or greater at 1.8 MPa. Representative Heat Deflection Temperatures of certain example thermoplastic engineering polymers are shown in Table 1.

TABLE 1

| | Representative |
|---|---|
| Type | HDT at 1.8 MPa (° C.) |
| Nylon 6 | 110 |
| Polycarbonate | 130 |
| Acetal Copolymer | 110 |
| PEEK | 150 |
| Polyamide-imide | 275 |
| POM | 110 |

In some embodiments, the thermoplastic engineering polymer of the composite composition preferably comprises a polyaryletherketone (PAEK) and in some embodiments that PAEK is poly (ether ketone) (PEK), poly(ether ether ketone) (PEEK), poly(ether ketone ketone) (PEKK), or mixtures thereof. In some preferred embodiments the thermoplastic engineering polymer is or comprises poly(ether ether ketone) (PEEK).

In some embodiments, the thermoplastic engineering polymer of the composite composition comprises polyamide (PA), polyamide-imide (PAI), polyether sulfone (PES), polyether-imide (PEI), polyphenylene sulfide (PPS), liquid-crystal polymer (LCP), polyoxymethylene (POM), acetal copolymer (AC), polycarbonate (PC) or mixtures thereof. By a “liquid crystalline polyester” (LCP) herein is meant a polyester polymer that is anisotropic when tested using the TOT test or any reasonable variation thereof, as described in U.S. Pat. No. 4,118,372. One preferred form of LCP is “all aromatic”, that is all of the groups in the polymer main chain are aromatic (except for the linking groups such as ester groups), but side groups that are not aromatic may be present. LCP useful as thermoplastic material in this invention has melting point up to 350° C. Melting points are measured per test method ASTM D3418. Melting points are taken as the maximum of the melting endotherm, and are measured on the second heat at a heating rate of 10° C./min. If more than one melting point is present the melting point of the polymer is taken as the highest of the melting points.

### Aramid Copolymer Including an Imidazole Group

The term “polymer,” as used herein, means a material prepared by polymerizing monomers, end-functionalized oligomers, and/or end-functionalized polymers whether of the same or different types. The term aramid, as used herein, means aromatic polyamide, wherein at least 85% of the amide (—CONH—) linkages are attached directly to two aromatic rings.

The term “aramid copolymer including an imidazole group” as used herein refers to copolymers prepared from aromatic diacids and diamines wherein there are at least two different diamines present, an aromatic diamine and an imidazole diamine. The two different diamines can be polymerized with a stoichiometric amount of one or more aromatic diacids.

Of the aromatic diacids, para-oriented aromatic diacids are preferred and the most preferred para-oriented aromatic diacid is terephthaloyl dichloride. Likewise, of the aromatic diamines, para-oriented aromatic diamines are preferred, and the preferred para-oriented aromatic diamine is paraphenylene diamine.

By “imidazole diamine”, it is meant a diamine having at least one imidazole group. Preferably, the imidazole diamine is a benzimidazole. In some preferred embodiments the imidazole diamine is 5(6)-amino-2-(p-aminophenyl) benzimidazole (DAPBI). In some preferred embodiments the aramid copolymer is made by polymerizing the monomers 5(6)-amino-2-(p-aminophenyl) benzimidazole, aromatic diamine(s), and aromatic diacid-chloride(s). In some most preferred embodiments, the aramid copolymer is made by polymerizing the monomers 5(6)-amino-2-(p-aminophenyl) benzimidazole, paraphenylene diamine, and terephthaloyl dichloride.

In some embodiments, the molar ratio of imidazole diamine, such as 5(6)-amino-2-(p-aminophenyl) benzimidazole, to the aromatic diamine is 50/50 to 80/20. In some specific embodiments, the aramid copolymer including an imidazole group includes a residue of 5(6)-amino-2-(p-aminophenyl) benzimidazole and a residue of paraphenylene diamine, wherein the molar ratio of the residue of 5(6)-amino-2-(p-aminophenyl) benzimidazole to the residue of paraphenylene diamine is 50/50 to 80/20. In some specific embodiments, the aramid copolymer including an imidazole group includes a residue of 5(6)-amino-2-(p-aminophenyl) benzimidazole and a residue of paraphenylene diamine, wherein the molar ratio of the residue of 5(6)-amino-2-(p-aminophenyl) benzimidazole to the residue of paraphenylene diamine is 50/50 to 70/30. In still other embodiments, imidazole diamine, such as 5(6)-amino-2-(p-aminophenyl) benzimidazole, is 50 mole percent or greater of the total moles of imidazole diamine and the aromatic diamine present.

As used herein, “stoichiometric amount” means the amount of a component theoretically needed to react with all of the reactive groups of a second component. For example, “stoichiometric amount” refers to the moles of terephthaloyl dichloride needed to react with substantially all of the amine groups of the amine components. It is understood by those skilled in the art that the term “stoichiometric amount” refers to a range of amounts that are typically within 10% of the theoretical amount. For example, the stoichiometric amount of terephthaloyl dichloride used in a polymerization reaction can be 90-110% of the amount of terephthaloyl dichloride theoretically needed to react with all of the amine groups.

In some embodiments, all of monomers can be combined together and reacted to form the polymer. In some embodiments, the monomers or various amounts of the monomers can be reacted sequentially to form oligomers which can be further reacted with additional monomer(s) or oligomer(s) to form polymers. By “oligomer,” it is meant polymers or species eluting out at <3000 MW with a column calibrated using polyparaphenylene diamine terephthalamide homopolymer.

As used herein, the term “residue” of a chemical species refers to the moiety that is the resulting product of the chemical species in a particular reaction scheme or subsequent formulation or chemical product, regardless of whether the moiety is actually obtained from the chemical species. Thus, a copolymer comprising residues of paraphenylene diamine refers to a copolymer having one or more units of the formula:

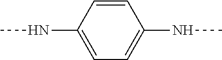

And a copolymer having residues of terephthaloyl dichloride contains one or more units of the formula:

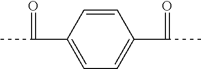

Similarly, a copolymer comprising residues of an imidazole group such as a benzimidazole group contains one or more units of the formula:

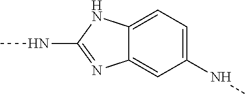

And specifically, a copolymer comprising residues of DAPBI contains one or more units of the formula:

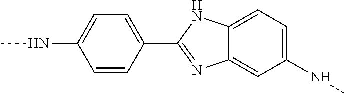

Therefore, in some embodiments, the aramid copolymer includes a residue of a benzimidazole, and in some embodiments the aramid copolymer includes a residue of 5(6)-amino-2-(p-aminophenyl).

### Raw Polymer Particles

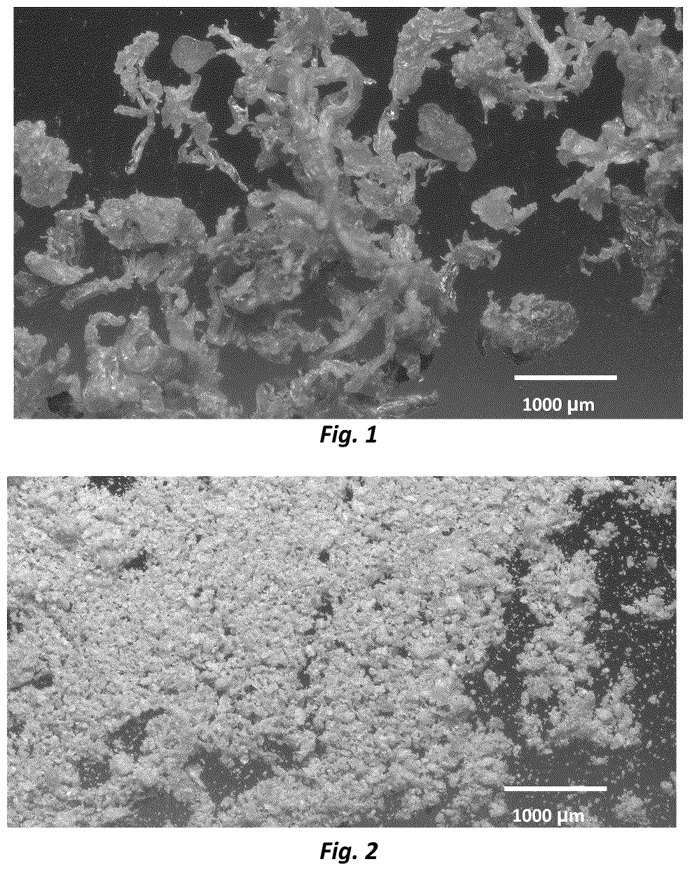

The composite composition can contain particles of aramid copolymer including imidazole groups are made by comminuting the copolymer to the desired size. For example, aramid polymer made in accordance with the teachings of United States Patent Publication 20130018138 is finished in the form of a water-wet acid crumb and rough ground while wet using various types of size-reduction equipment, including such equipment as hammer mills, disk mills, roll mills. The acid crumb is then preferably neutralized by washing with a base and then the neutralized crumb is isolated. The neutralized crumb can then be dried to form polymer particles that have an irregular size and that a majority thereof will pass through a mesh screen having 1.4 mm openings. FIG. 1 is a photograph that is representative of these particles, which are referred to herein as “raw polymer” particles. The specific raw polymer particles were made by the polymerization of the monomers 5(6)-amino-2-(p-aminophenyl) benzimidazole, paraphenylene diamine, and terephthaloyl dichloride.

The size of the aramid copolymer particles described herein can preferably be determined by classifying using any industrial method of sieving particles preferably using screens. An alternate method, generally used for very small particles, is by laser diffraction using DIN ISO 13320-2020, which can also determine fine particle diameters and their distribution.

A typical method of sieving particles uses a column of sieve trays of wire mesh screens of a graded mesh size. The material to be classified is poured onto the top sieve tray which has the largest screen openings. Each lower sieve tray in the column has smaller openings than the one above. The column of sieves trays is typically placed in a mechanical shaker, which shakes all the sieve trays in the column to facilitate movement of the particles on the surface of each mesh screen in each tray so that particles small enough to fit through the screen openings can fall through to the next sieve tray by gravity. After the shaking is complete, the particles remaining on each mesh screen of each sieve tray have a particle size too large to pass through the openings in that mesh screen.

While there are various systems of identifying the mesh sizes such as US Standard or Tyler mesh, herein any screen sizes are identified by their openings in millimeters to avoid confusion. Additionally, as used herein, the openings in the screen are assumed to be square openings; for example, a mesh screen having 0.150 mm openings has openings that are square, and each side of the square opening is nominally 0.150 mm.

In some embodiments, the raw polymer particles comprising aramid copolymer including an imidazole group have a size distribution such that at least 90 weight percent of the particles pass through a mesh screen having 1.4 mm openings, but 85 percent by weight or greater of those particles will not pass through a mesh screen having 0.212 mm openings. In other words, at least 75 weight percent of the raw polymer particles can be considered to range from about 0.212 to 1.4 mm in size.

### Ground Particles

Further, while the composite composition can comprise raw polymer particles, in some embodiments the raw polymer particles comprising aramid copolymer including an imidazole group are further comminuted to further reduce their particle size prior to their use in the composite composition. Such size reducing processes can include variants of the hammer mills, disk mills, roll mills, and the like that were previously mentioned, and other processes such as jet mills and twin-screw extruders that can be used to reduce particle sizes below 1 mm, preferably below 0.5 mm. In some preferred embodiments, a twin-screw extruder can be used as a mill to size-reduce the aramid copolymer particles comprising aramid copolymer including an imidazole group to particles of a desired size distribution.

In some embodiments, the particles comprising aramid copolymer including an imidazole group have a size distribution such that they will pass through a mesh screen having 0.425 mm openings but about 50 weight percent will not pass through a mesh screen having 0.150 mm openings. As used herein, such particles comprising aramid copolymer including an imidazole group that have been size-reduced to this range are considered “ground particles” herein. In other words, the ground particles can be considered to be smaller than about 0.425 mm, with about half of those particles being larger than 0.150 mm, meaning the particles have a median particle size or diameter or D50 that is about 0.150 mm.

One embodiment for making “ground particles” comprising aramid copolymer including an imidazole group utilizing the twin-screw extruder is referred to herein as a “dry extruder” process. In this type of process, the raw polymer as previously described is further size-reduced through the extruder in a dry state; that is, the polymer being size reduced has less than 10 weight percent moisture. FIG. 2 is a photograph that is representative of these dry extruder particles. Like FIG. 1, these ground particles were made by the polymerization of the monomers 5(6)-amino-2-(p-aminophenyl) benzimidazole, paraphenylene diamine, and terephthaloyl dichloride.

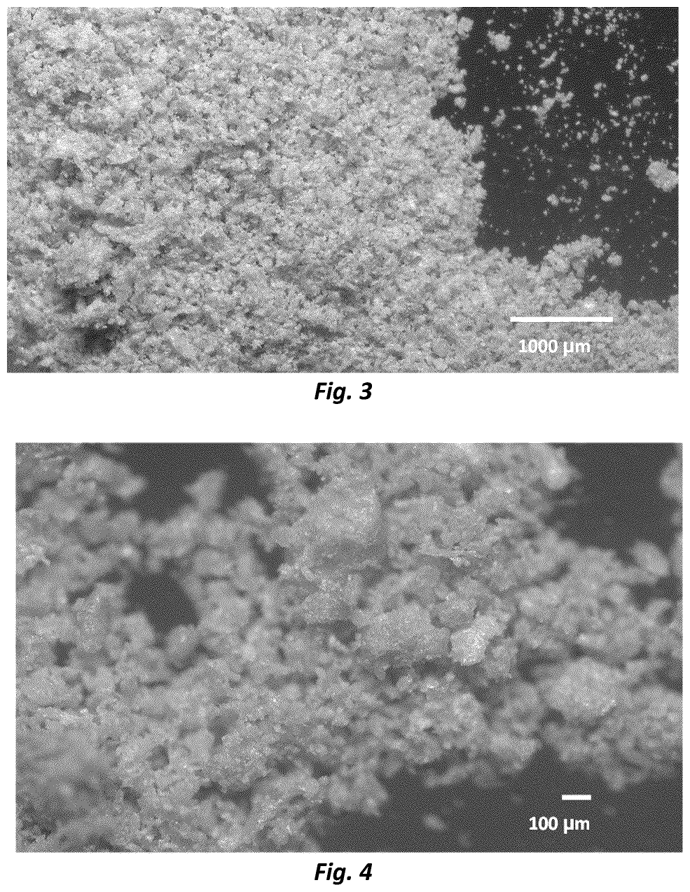

Another embodiment for making aramid copolymer particles of a size below 1 mm utilizing the twin-screw extruder is referred to herein as a “wet extruder” process. In this type of process, the neutralized crumb from polymerization is size-reduced only once through the twin-screw extruder to the desired size; the intermediate step of making raw polymer particles does not occur. FIGS. 3 & 4 are representative photographs of these wet extruder particles after being air-dried in a shallow tray. These ground particles were also made by the polymerization of the monomers 5(6)-amino-2-(p-aminophenyl) benzimidazole, paraphenylene diamine, and terephthaloyl dichloride.

The particles comprising aramid copolymer including an imidazole group made using the dry extruder process, and the particles comprising aramid copolymer including an imidazole group made using the wet extruder, are both considered “ground particles” in that both fit the definition herein of ground particles. It is believed that any minor differences in the particle size distribution of the particles do not affect their performance in the composite composition.

### Floc Particles

In some embodiments, the particles comprising aramid copolymer including an imidazole group are in the form of a floc in the composite composition. The term floc, as used herein, means fibers having a short length normally produced by cutting continuous fibers into the required lengths using well-known methods in the art. In some preferred embodiments the floc has a length of from about 0.5 to about 15 millimeters. A preferred length of floc is from about 1 to about 12 millimeters, and a most preferred length of floc is from about 1 to 6 millimeters. In some embodiments, the floc can have a linear density of 0.5 to 3 denier per filament, and in some embodiments, the floc can have a linear density of 0.75 to 2.25 denier per filament.

Representative methods of making floc include processes such as described in U.S. Pat. Nos. 8,501,071; 9,988,514; 9,994,974; 10,400,082; 10,400,357; and 11,279,800. Such processes can utilize a spinning solvent such as sulfuric acid and either the polymer crumb or the raw polymer particles previously mentioned herein to form a suitable polymer spinning solution. Such processes preferably provide continuous filaments that are further cut to short lengths to be used as floc.

If desired, the composite composition can contain a mixture of either the raw polymer particles or the ground particles of the aramid copolymer comprising an imidazole group and floc of the aramid copolymer comprising an imidazole group. The weight ratio of particles to floc can range from 1:4 to 4:1. In some embodiments, the composite composition can contain a mixture of either the raw polymer particles or the ground particles of the aramid copolymer comprising an imidazole group and a reinforcing floc of a different type, such as carbon fiber floc or glass floc; again the weight ratio of particles to floc can range from 1:4 to 4:1. Alternatively, in some embodiments, the composite composition can contain a mixture of floc of the aramid copolymer comprising an imidazole group and raw polymer particles or the ground particles of a different polymer or copolymer type; again the weight ratio of particles to floc can range from 1:4 to 4:1.

### Pellets of the Composite Composition

The particles of the aramid copolymer comprising an imidazole group can be combined with the thermoplastic engineering polymer in any suitable vessel or equipment that can mix the materials and uniformly disperse the particles in the engineering polymer. Such equipment can include such things as a batch mixer, a LIST kneader-reactor type mixer, or a single or twin screw extruder. Once the particles of the aramid copolymer comprising an imidazole group are combined with the thermoplastic engineering polymer to form the composite composition, the composite composition can be further shaped as desired; for example, pellets can be made of the composite composition for further use in various processes to make articles. For example, the molten composite composition can be made in a twin-screw extruder which additionally extrudes the molten composite composition through a die at the exit of the extruder, forming a molten strand of the composite composition that is thermally quenched; the solid or partially solid strand of the composite composition can then be directed to a pelletizer to make pellets. In some embodiments, the pellets are sized such that there are 25 to 45 pellets per gram. In some embodiments, the pellets have an average diameter of 1 to 3 mm.

Additionally, it is believed, if desired, these pellets can be further ground to make finer powders of the composite composition for use in specialty applications such as 3-D printing or additive manufacturing processes. Fine particles are typically characterized as having a certain D50, which is the median particle diameter or particle size of the distribution. For example, for a powder sample with a D50 that is 5 micrometers, it is meant 50% of particles are larger than 5 micrometers and 50% particles are smaller than 5 micrometers. This fine particle D50 is preferably determined by laser diffraction DIN ISO 13320-2020.

Fine powders of the composite composition having a D50 of 1 to 150 micrometers are thought useful. In some embodiments, these fine powders of the composite composition have a D50 of 30 to 150 micrometers. In some embodiments, the fine powders of the composite composition have a D50 of 45 to 120 micrometers, and in still other embodiments the fine powders of the composite composition have a D50 of 48 to 100 micrometers.

### Articles Comprising the Composite Composition

Articles can be made that comprise the composite composition. In some embodiments, the articles include those articles wherein the aramid copolymer particles are the sole particulate other than an optional pigment incorporated into the engineering polymer. In some other embodiments, the articles include articles comprising the aramid copolymer particles, an optional pigment, and one or more filler; wherein a filler is considered herein to be a particle that does not affect the wear properties or wear performance (such as noise) of the articles. In some other embodiments, the articles include articles wherein the aramid copolymer particles are the majority particulate additive by weight in the composite composition that is not a pigment or a filler. In still some other embodiments, the articles include articles wherein the aramid copolymer particles are the majority particulate additive by weight in the composite composition.

In many embodiments, the preferred articles are parts made from the composite composition when in a molten state, such extruded parts and injection molded parts; or parts that have been 3-D printed or additive manufactured, such as by fused deposition modeling (FDM), stereolithography (SLA), or selective laser sintering (SLS). Such parts can be, for example thin-walled parts or industrial large format parts for use in the automotive and/or aerospace industry.

### Wear Resistance

In many embodiments, the composite composition and articles made therefrom have improved wear resistance. The addition of the particles comprising aramid copolymer including an imidazole group reduce the wear rate of the thermoplastic engineering polymer by at least 25 percent, based on a comparison of the wear rate of a part made solely with the thermoplastic engineering polymer to the wear rate of a part made with the composite composition containing the thermoplastic engineering polymer and particles comprising aramid copolymer including an imidazole group dispersed therein. In some embodiments, the addition of the particles comprising aramid copolymer including an imidazole group reduce the wear rate of the thermoplastic engineering polymer by at least 45 percent, Surprisingly, the composite composition and article made therefrom have an average dynamic coefficient of friction that is equivalent to or less than the average dynamic coefficient of friction of an article consisting of only the thermoplastic engineering copolymer. In other words, surprisingly, the addition of these particles increases the wear performance of the material without increasing its friction coefficient.

### Process for Making the Composite Composition

In some embodiments, this invention relates to a process for making a composite composition including the steps of:
a) polymerizing monomers to form an aramid copolymer including an imidazole group, the monomers including at least one aromatic diacid and at least one aromatic diamine and one imidazole diamine;
b) comminuting and isolating the aramid copolymer including an imidazole group in the form of a polymer crumb of a desired particle size comprising aramid copolymer including an imidazole group;
c) optionally, further grinding or milling the polymer crumb to form particles comprising aramid copolymer including an imidazole group of a desired particle size; and
d) combining and mixing 3 to 30 parts by weight of said particles with up to 97 parts by weight of a thermoplastic engineering polymer to form the composite composition.

It should be understood that all of the various elements, features, definitions, and other explanations previously provided herein for the composite composition equally apply to the process for making the composite composition but are not repeated herein to avoid redundancy.

In this process, Step a) of polymerizing the monomers to form an aramid copolymer including an imidazole group is preferably accomplished using the general disclosure of solution polymerization as disclosed in US Patent Publication 20130018138A1. This process produces a wet polymer crumb similar to wet sand containing polymerization solvent and acidic byproduct, normally hydrochloric acid, which is produced during polymerization.

In step b) of the process, the wet polymer crumb is comminuted and isolated by grinding or milling (for example, using a hammer or disk mill) while washing the crumb with water or an aqueous solution to remove the polymerization solvent from the crumb. Optionally the crumb can additionally be washed with a base to remove acidic byproduct from the polymerization. The isolated polymer can then be optionally dried.

The isolated crumb is then optionally further comminuted to further size-reduce the crumb in step c) by grinding or milling the polymer crumb to a desired particle size. For example, as previously disclosed herein, the crumb can be comminuted to make the raw polymer particles, or the crumb can be comminuted to make the ground particles as previously described. Further, while for clarity it has been discussed herein that the crumb is comminuted into ground particles in two steps, as in the crumb is first size-reduced to raw polymer particles in step b), and then those raw polymer particles are then further size-reduced to ground particles in optional step c), it should be understood that it is possible to comminute the polymer crumb into “ground particles” directly in one step, which is step b). In some preferred embodiments, step c) is conducted in a twin-screw extruder that size-reduces the material to the desired size.

The particles comprising aramid copolymer including an imidazole group are then combined and mixed with the thermoplastic engineering polymer in step d), in proportions of 3 to 30 parts by weight of said particles with up to 97 parts by weight of a thermoplastic engineering polymer to form the composite composition. In some embodiments, 3 to 30 parts by weight of said particles with 70 to 97 parts by weight of a thermoplastic engineering polymer are used in step d) to form the composite. In some embodiments, 5 to 25 parts by weight of said particles with 75 to 95 parts by weight of a thermoplastic engineering polymer are used in step d) to form the composite.

Preferably, step d) is conducted in a twin-screw extruder. Typically, the thermoplastic engineering polymer is provided to the extruder in the form of solid pellets and these pellets, along with the particles comprising aramid copolymer including an imidazole group, can be conveniently metered into a twin screw extruder where they are combined and mixed, uniformly dispersing the particles comprising aramid copolymer including an imidazole group in the thermoplastic engineering polymer. Alternatively, any number of batch, semi-continuous, or continuous methods, using the thermoplastic engineering polymer in either solid and molten form, can be used to combine and mix the thermoplastic engineering polymer with the particles comprising aramid copolymer including an imidazole group.

In some embodiments, the process for making the composite composition includes making pellets of the composite composition during or after step d). For example, pelletizing equipment can be connected to the exit of the extruder, or the extruded composite composition can be pelletized in a separate step.

For example, the molten composite composition made in a twin-screw extruder can be extruded through a die at the exit of the extruder, following by a thermal quench, making a strand of the composite composition, which can then be directed to a pelletizer to make pellets. Preferably the pellets are sized such that there are 25 to 45 pellets per gram.

As previously discussed herein, in some embodiments, the thermoplastic engineering polymer used in the process for making the composite composition comprises poly (ether ketone) (PEK), poly(ether ether ketone) (PEEK), poly(ether ketone ketone) (PEKK), or mixtures thereof. In some preferred embodiments, thermoplastic engineering polymer used in the process for making the composite composition comprises poly(ether ether ketone) (PEEK). In some embodiments, the thermoplastic engineering polymer used in the process for making the composite composition comprises a polyamide (PA), polyamide-imide (PAI), polyether sulfone (PES), polyether-imide (PEI), polyphenylene sulfide (PPS), liquid-crystal polymer (LCP), polyoxymethylene (POM), acetal copolymer (AC), polycarbonate (PC), or mixtures thereof.

The monomers used in the polymerization step a) of the process for making the composite composition can include any of the monomers previously described herein. In some embodiments the monomers include the aromatic diacid terephthaloyl dichloride. In some embodiments the monomers include the aromatic diamine paraphenylene diamine. In some embodiments the monomers include the imidazole diamine in the form of a benzimidazole, preferably the benzimidazole 5(6)-amino-2-(p-aminophenyl) benzimidazole. In some embodiments, the monomers include 5(6)-amino-2-(p-aminophenyl) benzimidazole, paraphenylene diamine, and terephthaloyl dichloride.

As previously discussed herein, the process is useful for making a composite composition that has an average dynamic coefficient of friction that is equivalent to or less than the average dynamic coefficient of friction of the thermoplastic engineering copolymer.

### Test Methods

The wear rate reduction and coefficient of friction for each sample was determined using a frictional wear tester per the test method ASTM D3702-94.

For the three pad washer (3PW) testing, a diameter of 1.3125 inches was used. For the test conditions, the linear velocity was 0.18 m/min; the pressure applied to each specimen was 0.55 MPa; the atmospheric temperature 21 C; the test period of time was nominally 100 hours. The resulting PV was 0.1 MPa*m/s. Each specimen was subjected to sliding contact with 4140 steel as the mating member. Lubricant was not used in the test.

For the thrust washer (TW) testing, a diameter of 1.125 inches was used. For the test conditions, the machine speed was 500 RPM corresponding to a linear velocity of 0.7 m/min; the pressure applied to each specimen was 1.75 MPa; the atmospheric temperature was 21 C: the test period of time was nominally 100 hours. The resulting PV was 1.2 MPa*m/s. Each specimen was subjected to sliding contact with 4140 steel as the mating member. Lubricant was not used in the test.

Adhesion properties were determined according to DIN SPEC 19289:2022-08 “Fibre-reinforced composites—Measurement of Interfacial Shear Strength by means of a Micromechanical Single-Fibre Pull-Out Test.”

### Example 1

An aramid copolymer including imidazole groups was made as follows. The monomers 5(6)-amino-2-(p-aminophenyl) benzimidazole (DAPBI) and paraphenylene diamine (PPD), in amounts suitable for forming a copolymer having a DABPI/PPD monomer ratio of 70/30, were combined with a stoichiometric amount of terephthaloyl dichloride (TCI) in a solvent system comprising N-methyl-2-pyrrolidone (NMP) solvent and 4.5 weight percent calcium chloride (CaCl2) as a solubility enhancer. The monomers polymerized to form a copolymer.

After the polymerization was complete, the copolymer crumb was recovered, ground (by either hammer mill or a disk mill) and washed with sodium hydroxide to neutralize byproduct hydrochloric acid to form raw polymer particles of approximately 3 mm particles in the form of undried neutral crumb. The copolymer that had an inherent viscosity of about 6.4 dl/g. This procedure was repeated to make another aramid copolymer including imidazole groups having a DABPI/PPD monomer ratio of 50/50. This aramid copolymer also had an inherent viscosity of about 6.4 dl/g.

The raw polymer particles in the form of undried neutral crumb were then either used directly in the wet extruder process or dried to form particles of approximately 1 mm in size. The dried raw polymer was further processed into “dry extruder” ground particles by pulverizing the approximately 1 mm raw polymer particles using solid-state pulverization in a twin screw extruder in a dry state with less than 10% moisture present. The “wet extruder” ground particles were made by pulverizing a sample of the undried neutral crumb in a twin screw extruder. Samples of the dried 1 mm raw polymer particles were also used as shown in Table 2.

A portion of the 70/30 DABPI/PPD copolymer was converted into fibers, and then the fibers were chopped into floc having a 3 mm cut length. Additionally, samples of glass fiber floc, carbon fiber floc, and polytetrafluoroethylene (PTFE) powder were also obtained for comparison samples. The sample Items are summarized in Table 2.

TABLE 2

| ITEM | Polymer | Preparation |
|---|---|---|
| 1 | 50/50 | 1 mm Raw Polymer Particles (Hammer Mill) |
| 2 | 50/50 | 150 micron Dry Extruder Particles |
| 3 | 70/30 | 150 micron Wet Extruder Particles |
| 4 | 70/30 | 1 mm Raw Polymer Particles (Disk Mill) |
| 5 | 70/30 | 1 mm Raw Polymer Particles (Disk Mill) |
| 6 | 70/30 | 3 mm Floc |
| 7 | Glass | 5 mm Floc |
| 8 | Carbon | 5 mm Floc |
| 9 | PTFE | 3 micron powder |

After the various particles, floc, and powder were obtained they were combined and blended with thermoplastic engineering resin using a twin screw extruder. Items 1-10 from Table 1 were blended with a polyether-ether-ketone polymer (PEEK 150G™, purchased from Victrex). Extrusion temperatures were maintained between 350-400 C. The blends were pelletized and isolated as pellets. The pellets were used in an injection-molding machine, operating at a melting temperature of 400 C and a mold temperature of 175 C, to make test items that were three-pad washers (3PW) for low pressure-velocity testing and thrust washers (TW) for high pressure-velocity testing as shown in Table 3.

TABLE 3

| | | Weight % | Test |
|---|---|---|---|
| Blend | Item | Particles | Item(s) |
| 1 | None | 0 | 3PW, TW |
| 2 | 1 | 5 | 3PW |
| 3 | 1 | 10 | 3PW |
| 4 | 1 | 20 | 3PW |
| 5 | 2 | 5 | 3PW |
| 6 | 2 | 10 | 3PW |
| 7 | 2 | 20 | 3PW |
| 8 | 3 | 5 | 3PW |
| 9 | 3 | 10 | 3PW |
| 10 | 3 | 20 | 3PW |
| 11 | 4 | 10 | 3PW |
| 12 | 4 | 20 | 3PW |
| 13 | 5 | 10 | TW |
| 14 | 5 | 20 | TW |
| 15 | 6 | 10 | 3PW, TW |
| 16 | 6 | 20 | 3PW, TW |
| A | 7 | 10 | 3PW, TW |
| B | 8 | 10 | 3PW, TW |
| C | 9 | 2.5 | TW |

Using rotational wear testing per test method ASTM D3702-94, the 3-pad washers were tested over 70-96 hours with a counter surface of 4140 steel. The Pressure-Velocity of the 3-pad washer testing was 0.1 (MPa-m/s). Using the same test method thrust washers were tested over 24 hours with a counter surface of 4140 steel and a 1.2 Pressure-Velocity (MPa-m/s). The low pressure-velocity wear rate data obtained from the 3-pad washer testing is shown in Table 4. The blends of PEEK with the aramid copolymer having imidazole groups showed a reduction of the wear rate versus the control. For this testing, the dynamic coefficient of friction for the blended samples was substantially unchanged from the dynamic coefficient of friction of the control sample.

TABLE 4

| | | | Low VP | Wear | | |
|---|---|---|---|---|---|---|
| | | | Wear | Rate | | Coefficient |
| | | Weight | Rate | Reduc- | | of Friction |
| | | % | (grams/ | tion | Coefficient | Reduction |
| Blend | Item | Particles | min) | (%) | of Friction* | (%) |
| 1 | None | 0 | 33.2 | — | 0.54 | — |
| 2 | 1 | 5 | 18.2 | 45 | 0.54 | 0 |
| 3 | 1 | 10 | 11.9 | 64 | 0.52 | 3.7 |
| 4 | 1 | 20 | 6.9 | 79 | 0.53 | 1.9 |
| 5 | 2 | 5 | 17.2 | 48 | 0.60 | (11) |
| 6 | 2 | 10 | 13.8 | 58 | 0.53 | 1.9 |
| 7 | 2 | 20 | 8.7 | 73 | 0.55 | (1.9) |
| 8 | 3 | 5 | 10.5 | 68 | 0.55 | (1.9) |
| 9 | 3 | 10 | 10.8 | 67 | 0.52 | 3.7 |
| 10 | 3 | 20 | 5.0 | 85 | 0.59 | (9.3) |
| 11 | 4 | 10 | 6.1 | 82 | 0.58 | (7.4) |
| 12 | 4 | 20 | 6.2 | 81 | 0.54 | 0 |
| 16 | 6 | 10 | 3.8 | 88 | NA | — |
| 17 | 6 | 20 | 2.9 | 91 | NA | — |

*Standard Deviation = 0.2

The high pressure-velocity wear rate data obtained thrust washer testing is shown in Table 5. The blends of PEEK with the aramid copolymer having imidazole groups showed a reduction of the wear rate versus the control. For this testing, the blends of PEEK with the aramid copolymer having imidazole groups had a lower dynamic coefficient of friction than the dynamic coefficient of friction of the control sample, approaching the very low dynamic coefficient of friction of the PTFE blend.

TABLE 5

| | | | High VP | Reduc- | | |
|---|---|---|---|---|---|---|
| | | | Wear | tion | | Reduction in |
| | | | Rate | in Wear | Coeffi- | Coefficient |
| | | Weight | (grams/ | Rate | cient of | of Friction |
| Blend | Item | % | min) | (%) | Friction** | (%) |
| 1 | None | 0 | 12.8 × 10⁻⁶ | — | 0.425 | — |
| 13 | 5 | 10 | 2.36 × 10⁻⁶ | 82 | 0.330 | 22 |
| 14 | 5 | 20 | 1.87 × 10⁻⁶ | 85 | 0.320 | 25 |
| 15 | 6 | 10 | 2.23 × 10⁻⁶ | 83 | 0.378 | 11 |
| 16 | 6 | 20 | 0.92 × 10⁻⁶ | 93 | 0.379 | 11 |
| A | 7 | 10 | 4.88 × 10⁻⁶ | 62 | 0.363 | 15 |
| B | 8 | 10 | 7.08 × 10⁻⁶ | 45 | 0.407 | 4 |
| C | 9 | 2.5 | 3.50 × 10⁻⁶ | 73 | 0.318 | 25 |

**Standard Deviation = 0.05

### Example 2

A portion of the fibers made from the 70/30 DABPI/PPD aramid copolymer made in Example 1 was not cut into floc but was used to determine the adhesion properties between that aramid copolymer and certain thermoplastic engineering polymers, and to further compare the adhesion properties of those thermoplastic engineering polymers to the aramid copolymer versus the adhesion properties of those thermoplastic engineering polymers to the comparison to the para-aramid paraphenylene terephthalamide (PPD-T) homopolymer.

The adhesion properties between the materials were determined according to DIN SPEC 19289:2022-08 using a Textechno Fiber Matrix Adhesion Tester (FIMATEST). This is a micromechanical method involves embedding a single filament of the aramid copolymer (or comparison material) in a matrix of the thermoplastic engineering polymer, and then the fiber is pulled out from the matrix of at a constant rate of extension (CRE) while the force displacement curve is recorded, from the apparent interfacial shear strength, the local interfacial shear strength, and the critical interfacial energy release rate can be determined. Specifically, each filament tested was embedded in the matrix of thermoplastic engineering polymer (TEP) as follows. The TEP was held in the crucible at room temperature and nitrogen flushed for 5 minutes. The TEP temperature was increased to above the melting temperature and held at that temperature for 10 minutes to completely melt the TEP. The filament was positioned in the center of the polymer matrix, then the filament was embedded at a rate of 300 μm/min to a targeted 90 μm embedding depth. The filament was held in position at 400° C. for 30 seconds then nitrogen cools the matrix to 300° C. during a time of 3-minutes, holding at 300° C. for 1 second and then cooling to 50° C. over a 5-minute period. The samples were then held at ambient temperature over night before the pull-out is performed. Finish-free filaments were used in the testing.

Table 6 and Table 7 summarize the adhesion data generated using DIN SPEC 19289:2022-08 The data in these tables compares the aramid copolymer filament to the PPD-T filament in various engineering polymers, including poly(ether ether ketone) (PEEK), polycarbonate (PC), and polyamide (PA) in the form of nylon-6(PA-6). Specifically, Table 6 and Table 7 summarize the apparent interfacial shear strength (τₐₚₚ), the local interfacial shear strength (τ_{d}), and the critical interfacial energy release rate (G_{ic}) of the fiber material polymer to the engineering polymer, with Table 6 providing data for “finish-free” fiber material and Table 7 providing data for a fiber material having a spin finish. This data illustrates the percent improvement in adhesion (Δ) to the engineering polymer by the aramid copolymer versus the PPD-T para-aramid homopolymer based on these adhesion properties. Additionally, it was found the presence of a spin finish did not detract from the adhesive performance but instead augmented the adhesion performance of the aramid copolymer particles to the engineering polymers, which would be an unexpected advantage for the use of floc particles in articles of thermoplastic engineering polymers. A fiber finish is normally desired in a fiber cutting operation, to more readily allow continuous filaments to be chopped into floc, and it would be advantageous to not have to remove finish from the chopped floc prior to its use as particles in the composite composition.

TABLE 6

| | | Eng. | τₐₚₚ | Δ | τ_{d} | Δ | G_{ic} | Δ |
|---|---|---|---|---|---|---|---|---|
| Filament | Finish? | Polymer | (MPa) | (%) | (MPa) | (%) | (J/m²) | (%) |
| Copolymer | No | PEEK | 56 | 75 | 70 | 52 | 26 | 100 |
| P-aramid | No | PEEK | 32 | | 46 | | 13 | |
| Copolymer | No | PC | 38 | 19 | 72 | 9 | 30 | 0 |
| P-aramid | No | PC | 32 | | 66 | | 30 | |
| Copolymer | No | PA - 6 | 37 | 3 | 63 | 0 | 23 | 0 |
| P-aramid | No | PA - 6 | 36 | | 63 | | 23 | |

TABLE 7

| | | Eng. | τₐₚₚ | Δ | τ_{d} | Δ | G_{ic} | Δ |
|---|---|---|---|---|---|---|---|---|
| Filament | Finish? | Polymer | (MPa) | (%) | (MPa) | (%) | (J/m²) | (%) |
| Copolymer | Yes | PEEK | 66 | 89 | 76 | 49 | 28 | 65 |
| P-aramid | Yes | PEEK | 35 | | 51 | | 17 | |
| Copolymer | Yes | PC | 33 | 18 | 96 | 35 | 56 | 100 |
| P-aramid | Yes | PC | 28 | | 71 | | 28 | |
| Copolymer | Yes | PA - 6 | 38 | 3 | 59 | 9 | 23 | 28 |
| P-aramid | Yes | PA - 6 | 37 | | 54 | | 18 | |

1. A composite composition, comprising:
a) 3 to 30 parts by weight particles comprising aramid copolymer including an imidazole group, and
b) up to 97 parts by weight of a thermoplastic engineering polymer; wherein said particles are uniformly dispersed in the thermoplastic engineering polymer and reduce the wear rate of the thermoplastic engineering polymer by at least 25 percent.

2. The composite composition of claim 1 comprising:
a) 5 to 25 parts by weight of the particles comprising aramid copolymer including an imidazole group, and
b) 75 to 95 parts by weight of a thermoplastic engineering polymer.

3. The composite composition of claim 1 wherein the particles comprising aramid copolymer including an imidazole group reduce the wear rate of the thermoplastic engineering copolymer by at least 45 percent.

4. The composite composition of claim 3 wherein the particles comprising aramid copolymer including an imidazole group reduce the wear rate of the thermoplastic engineering copolymer by at least 80 percent.

5. The composite composition of claim 1 wherein the thermoplastic engineering polymer is poly (ether ketone) (PEK), poly(ether ether ketone) (PEEK), poly(ether ketone ketone) (PEKK), or mixtures thereof.

6. The composite composition of claim 5 wherein the thermoplastic engineering polymer is poly(ether ether ketone) (PEEK).

7. The composite composition of claim 1 wherein the thermoplastic engineering polymer comprises a polyamide (PA), polyamide-imide (PAI), polyether sulfone (PES), polyether-imide (PEI), polyphenylene sulfide (PPS), liquid-crystal polymer (LCP), polyoxymethylene (POM), acetal copolymer (AC), polycarbonate (PC) or mixtures thereof.

8. The composite composition of claim 1 wherein the local interfacial shear strength (τ_{d}) between the particles of aramid copolymer including an imidazole group and the engineering polymer is greater than a local interfacial shear strength (τ_{d}) between the particles of a para-aramid homopolymer such as PPD-T and the same engineering polymer.

9. The composite composition of claim 8 wherein the local interfacial shear strength (τ_{d}) between the particles of aramid copolymer including an imidazole group and the engineering polymer is at least 9 percent or greater than the local interfacial shear strength (τ_{d}) between the particles of a para-aramid homopolymer such as PPD-T and the same engineering polymer.

10. The composite composition of claim 9 wherein the local interfacial shear strength (τ_{d}) between the particles of aramid copolymer including an imidazole group and the engineering polymer is at least 35 percent or greater than the local interfacial shear strength (τ_{d}) between the particles of a para-aramid homopolymer such as PPD-T and the same engineering polymer.

11. The composite composition of claim 1 wherein the local interfacial shear strength (τ_{d}) between the particles of aramid copolymer including an imidazole group and the engineering polymer is 72 MPa or greater.

12. The composite composition of claim 1 wherein the aramid copolymer including an imidazole group includes is a residue of paraphenylene diamine.

13. The composite composition of claim 12 wherein the aramid copolymer including an imidazole group further includes a residue of 5(6)-amino-2-(p-aminophenyl) benzimidazole and wherein the molar ratio of the residue of 5(6)-amino-2-(p-aminophenyl) benzimidazole to the residue of paraphenylene diamine is 50/50 to 80/20.

14. The composite composition of claim 13 wherein the aramid copolymer including an imidazole group further includes a residue of 5(6)-amino-2-(p-aminophenyl) benzimidazole and wherein the molar ratio of the residue of 5(6)-amino-2-(p-aminophenyl) benzimidazole to the residue of paraphenylene diamine is 50/50 to 70/30.

15. The composite composition of claim 1 wherein the aramid copolymer including an imidazole group includes a residue of 5(6)-amino-2-(p-aminophenyl) benzimidazole.

16. The composite composition of claim 1 wherein the particles comprising aramid copolymer including an imidazole group are in the form of ground or milled polymerized crumb.

17. The composite composition of claim 1 wherein the particles comprising aramid copolymer including an imidazole group have a size distribution such that 90 weight percent of the particles will pass through a mesh screen having 1.4 mm openings, with 85 percent by weight or greater of those particles not passing through a mesh screen having 0.212 mm openings.

18. The composite composition of claim 1 wherein the particles comprising aramid copolymer including an imidazole group have a size distribution such that they will pass through a mesh screen having 0.425 mm openings, with 50 weight percent not passing through a mesh screen having 0.150 mm openings.

19. The composite composition of claim 1 wherein the particles comprising aramid copolymer including an imidazole group are in the form of a floc.

20. The composite composition of claim 19 wherein the floc has a cut length of 0.5 to 15 millimeters.

21. The composite composition of claim 20 wherein the floc has a cut length of 1 to 6 millimeters.

22. An article comprising the composite composition of claim 1.

23. The article of claim 22 having an average dynamic coefficient of friction that is equivalent to or less than the average dynamic coefficient of friction of an article consisting of only the thermoplastic engineering copolymer.

24. The article of claim 22 in the form of extruded pellets having a size such that there are 25 to 45 pellets per gram.

25. The article of claim 22 in the form of extruded pellets having an average diameter of 1 to 3 mm.

26. A process for making a composite composition including the steps of
a) polymerizing monomers to form an aramid copolymer including an imidazole group, the monomers including at least one aromatic diacid and at least one aromatic diamine and one imidazole diamine;
b) comminuting and isolating the aramid copolymer including an imidazole group in the form of a polymer crumb of a desired particle size comprising aramid copolymer including an imidazole group;
c) optionally, further grinding or milling the polymer crumb to form particles comprising aramid copolymer including an imidazole group of a desired particle size; and
d) combining and mixing 3 to 30 parts by weight of said particles with up to 97 parts by weight of a thermoplastic engineering polymer to form the composite composition.

27. The process for making the composite composition of claim 26 wherein the thermoplastic engineering polymer is poly (ether ketone) (PEK), poly(ether ether ketone) (PEEK), poly(ether ketone ketone) (PEKK), or mixtures thereof.

28. The process for making the composite composition of claim 27 wherein the thermoplastic engineering polymer is poly(ether ether ketone) (PEEK).

29. The process for making the composite composition of claim 26 wherein the thermoplastic engineering polymer comprises a polyamide (PA), polyamide-imide (PAI), polyether sulfone (PES), polyether-imide (PEI), polyphenylene sulfide (PPS), liquid-crystal polymer (LCP), polyoxymethylene (POM), acetal copolymer (AC), polycarbonate (PC), or mixtures thereof.

30. The process for making the composite composition of claim 26 wherein the aromatic diacid is terephthaloyl dichloride.

31. The process for making the composite composition of claim 26 wherein the aromatic diamine is paraphenylene diamine.

32. The process for making the composite composition of claim 26 wherein the imidazole diamine is 5(6)-amino-2-(p-aminophenyl) benzimidazole.

33. The process for making the composite composition of claim 26 wherein step c) is conducted in a twin-screw extruder. 10 34. The process for making the composite composition of claim 26 wherein step d) is conducted in a twin-screw extruder.

35. The process for making a composite composition of claim 26 wherein pellets of said composite composition are made during or after step d).
